(19) United States
(12) Patent Application Publication
(10) Pub. No.: US 2026/0363939 A1
(43) Pub. Date: Nov. 19, 2026

(54) SYSTEM AND APPARATUS FOR A MASSAGE THERAPY TOOL

(71) Applicant: OneSoma Bodywork LLC, Torrance, CA (US)

(72) Inventors: Isabel Kelly, Torrance, CA (US); Dale John Burrowes, Monmouth (GB); Milo Sebastian Deane, Worcester (GB)

(21) Appl. No.: 19/209,055

(22) Filed: May 15, 2025

(51) Int. Cl. A61H 7/00

(52) U.S. Cl. CPC A61H 7/003; A61H 2201/1638; A61H 2201/1695

(57) ABSTRACT

A hand-held massage tool includes a main body with a contoured first side forming a rounded protrusion at a first end and a ridge extending from the protrusion to a second end, sloping downward. The second side, opposite the first, defines an opening. A cap covers the opening and, together with the main body, creates an interior volume. A fastener secures the main body to the cap, ensuring a stable connection. The tool’s design allows for efficient pressure application across various areas of the body, with the contoured protrusion providing targeted relief while the ridge offers versatility for different massage techniques. The ergonomic design is optimized for comfort and ease of use, making the tool ideal for professional and personal massage applications. The cap may be easily secured and removed for cleaning or maintenance.

### BACKGROUND

Massage tools have been widely used in therapeutic practices to enhance the effectiveness of treatments. These tools come in a variety of forms, ranging from simple handheld devices to more advanced designs. Many are created to assist in applying pressure to different parts of the body, with some offering adjustable features to suit various massage techniques. The diversity of existing tools allows therapists to tailor their approach to meet individual client needs, providing relief and relaxation through mechanical means.

Despite the range of available tools, there remains a need for more specialized designs that may deliver targeted pressure and greater versatility. Existing tools often lack the ability to accommodate specific body contours or provide the precise level of pressure required for certain therapeutic techniques. As a result, there is a demand for innovations that may offer improved functionality and adaptability in both professional and personal massage settings.

### SUMMARY

Accordingly, embodiments described herein include a hand-held massage tool including a main body, comprising a first side contoured to form a rounded protrusion at a first end of the main body and a ridge extending from the rounded protrusion to a second end of the main body. The ridge slopes downward toward the second end. In some embodiments, a second side, opposite the first side, defines an opening. A cap covers the opening and forms an interior volume in cooperation with the main body. In some embodiments, a fastener secures the main body to the cap.

In some embodiments, the hand-held massage tool includes a strap assembly operable to secure the hand-held massage tool to a hand of a user, wherein at least a portion of the strap assembly is positioned between the cap and the main body. In some embodiments, the strap assembly comprises a central region disposed within the interior volume and two or more straps extending from the central region and out of the interior volume through an interface between the main body and the cap. In some embodiments, the strap assembly includes a single strap or one strap. In some embodiments, the rounded protrusion has a size and shape corresponding to an end of an olecranon.

In some embodiments, the main body comprises an aperture configured to receive the fasteners through a fastener opening defined by the cap. In some embodiments, an exterior-facing surface of the cap has a convex geometry. In some embodiments, the rounded protrusion and the ridge are symmetric along an axis that extending from the first end of the main body to the second end of the main body. In some embodiments, the rounded protrusion is a first rounded protrusion and the first side of the main body is further contoured to include a second rounded protrusion at a second end of the main body that is smaller than the first rounded protrusion.

In some embodiments, the main body further comprises a first protrusion extending into the interior volume and wherein the first protrusion defines an aperture. In some embodiments, the cap comprises a second protrusion extending into the interior volume that defines a fastener opening aligned with the aperture. In some embodiments, the fastener extends through the fastener opening and comprises a distal end engaged within the aperture defined by the first protrusion.

Other aspects and advantages of the described embodiments will become apparent from the following detailed description taken in conjunction with the accompanying drawings which illustrate, by way of example, the principles of the described embodiments.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is noted, however, that the appended drawings illustrate only some aspects of this disclosure and the disclosure may admit to other equally effective embodiments.

To facilitate understanding, identical reference numerals have been used, where possible, to designate identical elements that are common to the figures. It is contemplated that elements and features of one embodiment may be beneficially incorporated in other embodiments without further recitation.

FIG. 1A shows a perspective view of exemplary components of a hand-held massage tool, in accordance with some embodiments;

FIGS. 1B-1C show side views of the exemplary components depicted in FIG. 1A, in accordance with some embodiments;

FIG. 2 shows perspective views illustrating internal-facing features of the exemplary components of FIGS. 1A-1B, in accordance with some embodiments;

FIG. 3A shows a front view of the hand-held massage tool, in accordance with some embodiments;

FIG. 3B shows a side cross-sectional view of the handheld massage tool, in accordance with some embodiments

FIG. 4 shows an exploded view of the hand-held massage tool, in accordance with some embodiments;

FIG. 5 shows a side view of the hand-held massage tool, in accordance with some embodiments; and

FIG. 6 shows a perspective view of the hand-held massage tool, in accordance with some embodiments.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure may be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” “approximately” “about” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but may include embodiments implemented in software, or combinations of software and hardware, and vice-versa, as will be apparent to those skilled in the art, unless otherwise specified herein. In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The embodiments described herein relate to a hand-held massage tool that offers enhanced precision and ergonomic support for delivering therapeutic treatments. The hand-held massage tool includes a main body with two rounded protrusions and a central ridge, designed to apply focused pressure to targeted muscle groups. A contoured shape allows for efficient transitions across different areas of the human body, while the ergonomic design ensures comfort during extended use.

In some embodiments, the hand-held massage tool is equipped with a secure strap assembly, allowing the user to maintain control and stability while applying substantial pressure. Such control and stability not only improves the effectiveness of the massage tool but also reduces strain on the hands, wrists, and joints, of the user/practitioner making the embodiments herein particularly advantageous for massage therapists who perform treatments repeatedly. By alleviating the wear and tear often associated with manual massage techniques, the embodiments disclosed herein promotes better long-term physical health for professionals.

In some embodiments, the hand-held massage tool includes a detachable cap that forms an internal volume when connected to the main body, providing potential for customization and the addition of accessories. The simple fastening mechanism makes it easy to assemble and disassemble, offering convenience and adaptability for various therapeutic applications.

Overall, the hand-held massage tool described below improves the precision, control, and efficiency of massage therapy while reducing the physical strain on the user. Its versatility and ergonomic advantages make it an ideal solution for both professional and personal use. For example, many therapists and practitioners often incorporate elbows into techniques for providing deep pressure and affect large muscle groups. Such elbow incorporation may include pressing, rolling, or kneading. Applying targeted pressure to specific areas releases tension, improves circulation, and alleviates muscle soreness.

The use of elbows may be particularly advantageous for addressing tight knots or trigger points in the muscles of a patient. However, as a result of elbow incorporation, over time, the strain on the back muscles and especially the lower back muscles of the practitioner/therapist, leads to discomfort, fatigue and even injury. Accordingly, the embodiments disclosed herein describe a tool that allows therapists to apply techniques similar to those applied with their elbows without having to bend over their customers and risk future pain and/or injury, which is discussed in detail further below.

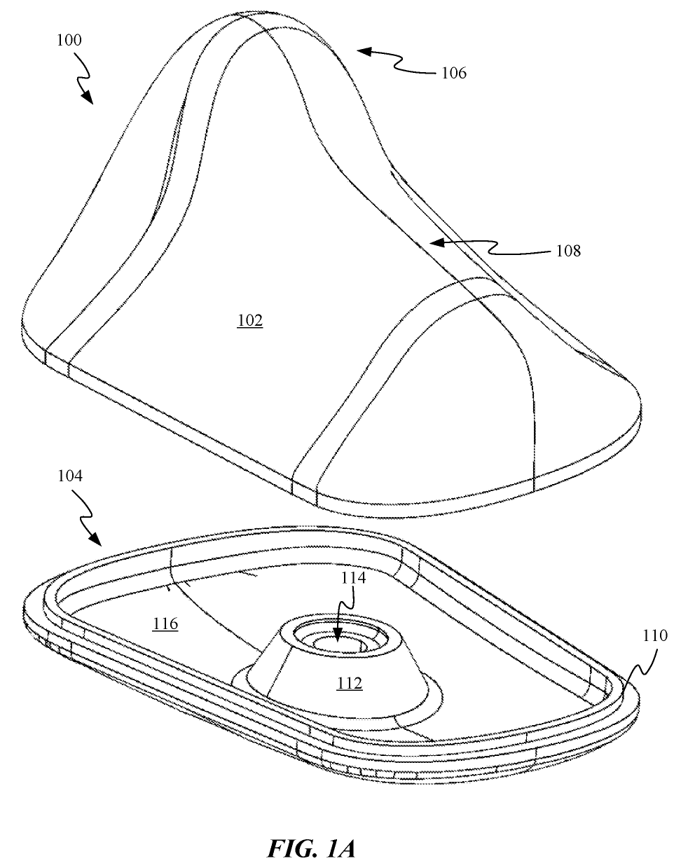

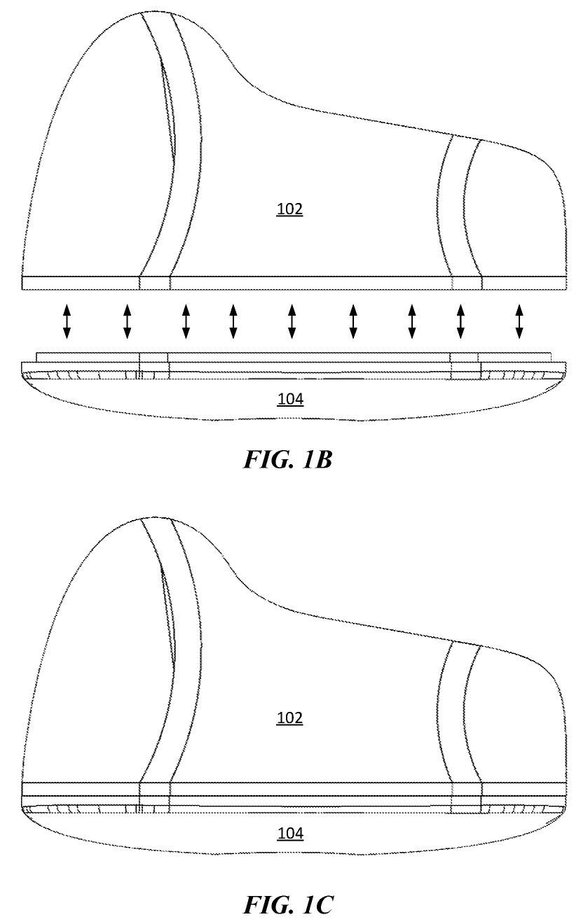

Referring to FIGS. 1A-1C, FIGS. 1A-1C illustrate a hand-held massage tool 100 (hereinafter “tool 100”) and components thereof, in accordance with some embodiments. FIG. 1A illustrates a perspective view showing a main body 102 and a detachable cap 104. Main body 102 may be configured with a contoured shape, allowing the first side of tool 100 to be used as a surface for applying therapeutic pressure.

Advantageously, main body 102 includes a rounded protrusion 106 located at a first end of main body 102. Rounded protrusion 106 mimics the geometry of the distal end of the ulna bone, known as the olecranon, commonly used by massage therapists to apply focused pressure. Such protrusion allows the tool to simulate similar pressure application techniques, making tool 100 highly effective for targeted muscle treatment.

n some embodiments, extending from the rounded protrusion 106 is a ridge 108. As shown in FIG. 1A, Ridge 108 runs along the length of main body 102, tapering down towards the second end. Such ridge facilitates the distribution of pressure along the body, enabling smooth and controlled massage strokes

In some embodiments, the downward-facing side of main body 102 (not visible in FIG. 1A) includes an opening designed to engage with the cap 104. The cap 104 is constructed to fit securely onto main body 102, aided by an alignment ridge 110. This ridge ensures that the cap 104 remains correctly aligned with the main body, even when the tool is subjected to rotational or lateral forces during use. The alignment feature helps prevent the cap from twisting or becoming misaligned, providing a stable and reliable connection between the components. FIG. 1A also shows that the cap 104 includes a first interior-facing protrusion 112, which defines a fastener opening 114. This opening is configured to accommodate a fastener head, recessed beneath the exterior surface of the cap, ensuring a smooth exterior profile and preventing any interference during use. Additionally, the interior surface of the cap 104 is concave, resulting in a convex exterior surface, which contributes to the tool's ergonomic design and enhances the user’s grip during operation.

FIG. 1B illustrates the assembly process for tool 100, showing how main body 102 and the cap 104 are joined together. The arrows indicate the alignment and attachment process, where the cap 104 is fitted into place and secured to main body 102 through the use of fasteners. Once the cap 104 is aligned and attached, it contributes to the overall structural integrity of the tool.

FIG. 1C shows the fully assembled tool 100, where main body 102 and cap 104 are securely mated to form a unified structure. The fastener ensures a tight bond between the components, and the precise alignment prevents any discontinuities or gaps at the interface between main body 102 and the cap 104. The result is a smooth, continuous exterior surface, free from irregularities, which enhances the tool's functionality and aesthetics. This seamless integration of components not only improves the durability of the tool but also ensures comfort during extended use, making tool 100 ideal for both professional and personal applications.

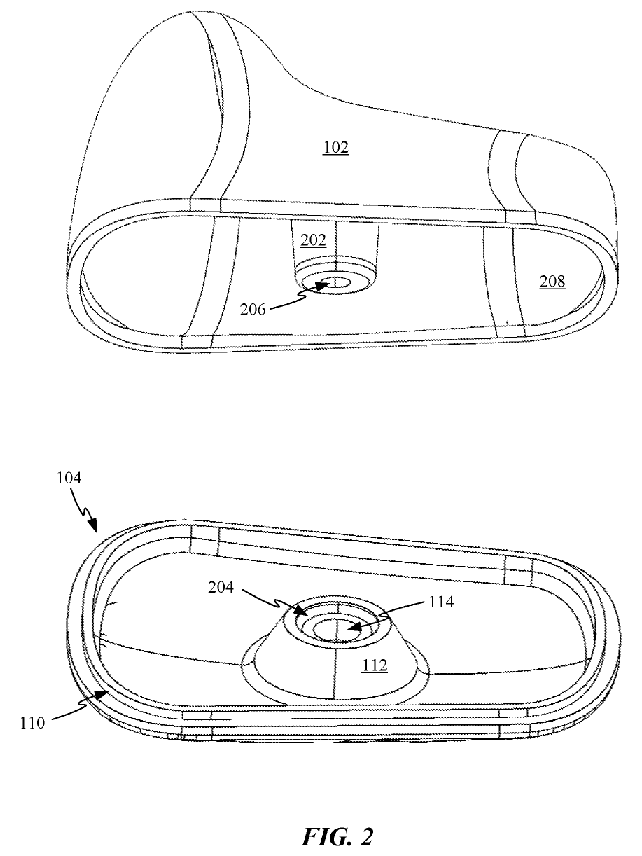

Referring now to FIG. 2, FIG. 2 shows perspective views of main body 102 and cap 104 both tilted to reveal interior features of main body 102 and cap 104. In particular, main body 102 includes a second interior-facing protrusion 202 configured to engage and mate with first interior-facing protrusion 112. Interior-facing protrusion 112 includes a recess 204 sized to receive a distal end of second protrusion 202 and align first protrusion 112 with second protrusion 202. In this way, first protrusion 112 is aligned with second protrusion 202 such that fastener opening 114 is aligned with an aperture 206 defined by second protrusion 202.

In one embodiment, aperture 206 may be threaded. In another embodiment, aperture 206 may include as fast release mechanism. For example, in one embodiment, aperture 206 may include a threaded fastener to secure the cap to the main body. In another embodiment, aperture 206 may incorporate one or more alternative fastening mechanisms, such as a snap-fit connection, a magnetic clasp, or an interlocking latch for easy assembly and disassembly. Other embodiments may use a ball bearing and pin lock, which secures the cap by locking ball bearings into a corresponding slot, or a bayonet mount, allowing the cap to twist and lock into place. Additional options may include a detent mechanism for a firm snap connection, a push-button release pin for quick fastening, a cam lock for secure rotational locking, or a sliding locking mechanism to hold the parts firmly together.

FIG. 2 also shows a size and shape of an opening 208 defined by main body 102 that may be closed up by cap 104. In some embodiments, an interior volume enclosed by main body 102 and cap 104 may be configured to receive one or more weighted components to help achieve a desired weight for tool 100.

Referring now to FIG. 2, perspective views of main body 102 and the cap 104 of the hand-held massage tool are illustrated, both tilted to reveal their interior structural features. Main body 102 includes a second interior-facing protrusion 202, which is specifically designed to engage and mate with the first interior-facing protrusion 112 of the cap 104. This engagement is advantageous for aligning the components securely when assembling tool 100. The second protrusion 202 is centrally located within the main body’s interior and includes aperture 206, which receives a fastener. This configuration ensures a stable and durable connection between main body 102 and the cap 104 during use, allowing for the application of significant pressure without compromising the integrity of the tool.

The first interior-facing protrusion 112 on the cap 104 includes a recess 204 that is precisely sized to accommodate the distal end of the second protrusion 202. This interlocking design ensures that the two protrusions are properly aligned when the cap is attached to the main body, facilitating the insertion of the fastener through the fastener opening 114. The alignment between these protrusions also ensures that the assembly process is simple and secure, with aperture 206 of the second protrusion 202 perfectly aligning with the fastener opening 114 in the first protrusion 112. This design feature not only contributes to the structural stability of tool 100 but also allows for quick disassembly, if needed, for cleaning or maintenance.

Additionally, FIG. 2 highlights the shape and size of an opening 208 defined by main body 102, which may be sealed by the cap 104 when the tool is fully assembled. This opening plays a functional role, as it defines an interior volume that may be enclosed once the cap 104 is secured. In some embodiments, this enclosed interior volume may be configured to house one or more weighted components. The inclusion of such weighted elements allows for adjustments to the overall weight of the hand-held massage tool, catering to the preferences of the user or the specific requirements of different massage techniques. For example, by altering the weight, users may customize the tool’s pressure application to meet their preferences or accommodate different massage techniques, ranging from light relaxation massages to deeper, more intense therapeutic treatments.

In some embodiments, beyond weighted components, the interior volume may also serve as a storage space for other components. For example, the strap assembly, which is used to secure tool 100 to the user's hand during operation, may be stored within the interior volume when not in use. In some embodiments, the strap assembly may include multiple adjustable straps or a central region that may be folded compactly and placed inside the tool. Such storage feature would make the tool more versatile, as users may store the straps neatly inside the tool when not needed, ensuring a clean and streamlined design without external components protruding when not in use. This built-in storage solution also protects the straps from damage, wear, or misplacement, ensuring they are readily available when needed

In some embodiments, the interior space may be adapted to house additional accessories or interchangeable components. For instance, interchangeable massage heads, rollers, or textured attachments may be stored within the tool, allowing users to swap them out depending on the type of massage desired. The ability to store multiple accessories within the tool itself enhances portability and convenience, making it an all-in-one solution for a wide range of massage applications. Users may carry the tool with its accessories inside, eliminating the need for separate storage cases or bags.

The modular nature of the embodiments herein opens up possibilities for future enhancements or upgrades, such as incorporating vibrational or heating elements within the interior volume. For example, in some embodiments, such vibrational or heating elements may be powered by a small battery stored within the same space, further enhancing the versatility of tool 100. In some embodiments, a heated element may include a heating pouch that may be heated via chemical heat or in a microwave and inserted into the interior volume of the tool. By enclosing such components inside the tool, the embodiments herein remain compact and ergonomic, while offering advanced functionality for users seeking deeper therapeutic benefits.

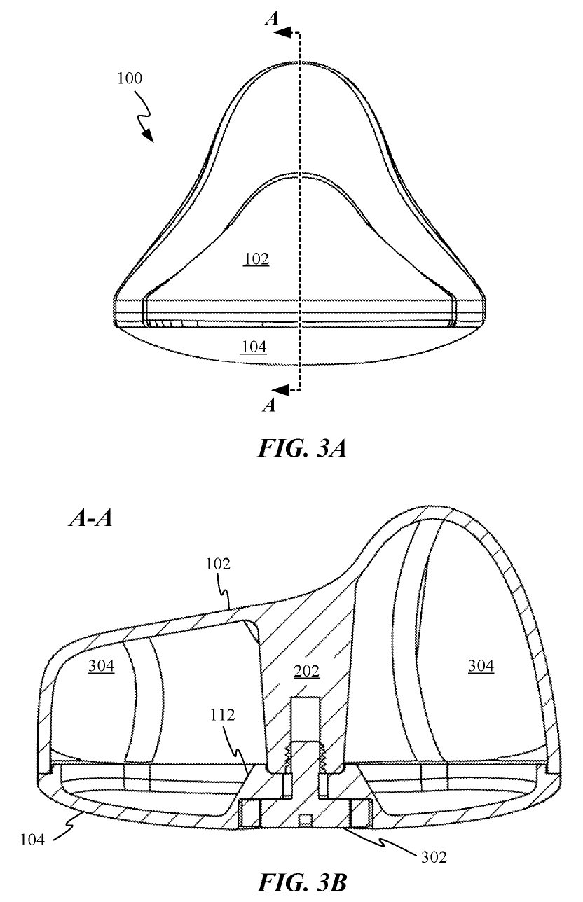

Referring now to FIGS. 3A-3B, FIG. 3A illustrates a front view of tool 100, emphasizing the symmetric design about section line A-A. This symmetry is a key feature, ensuring that the geometry of the tool remains balanced and may be comfortably used in either the left hand or right hand of a massage therapist. By maintaining a symmetrical shape along section line A-A, tool 100 allows for interchangeable use without compromising ergonomics or functionality. Such flexibility is particularly beneficial in professional settings, where therapists frequently switch between hands during treatments to alleviate strain or better target specific muscle groups. The symmetric design ensures that no matter which hand is used, the tool delivers consistent pressure and contact, enhancing its versatility for a wide range of therapeutic techniques.

FIG. 3B provides a cross-sectional view of tool 100 along section line A-A, as indicated in FIG. 3A. This cross-section reveals the internal assembly of the tool, focusing on how the cap 104 is secured to main body 102 using a fastener 302. The fastener 302 extends through the fastener opening located in the first interior-facing protrusion 112 of the cap and threads into the corresponding aperture defined by the second interior-facing protrusion 202 of main body 102. This fastening mechanism creates a strong, stable connection between the cap and the main body, ensuring that the two parts remain securely joined even under the pressure applied during massage treatments.

Additionally, FIG. 3B illustrates how, in some embodiments, the distal end of the second interior-facing protrusion 202 fits precisely into a recess defined by the first interior-facing protrusion 112. This precise fit not only aids in aligning the components during assembly but also enhances the structural integrity of tool 100, reducing any potential for misalignment or wobbling during use. The cross-section also reveals the interior volume 304 formed by main body 102 and the cap 104. This interior space may be utilized for a variety of purposes, including the storage of additional components such as weighted elements or even the strap assembly when not in use, as previously discussed. The interior volume 304 is designed to maximize space efficiency while maintaining the compact and ergonomic profile of tool 100.

The combination of the fastener mechanism and the recessed alignment of the protrusions ensures a seamless external appearance, free from visible gaps or misalignments at the interface between the cap 104 and main body 102. This contributes to both the aesthetic appeal and functional durability of tool 100, making it ideal for repeated use in professional environments where consistency and reliability are advantageous.

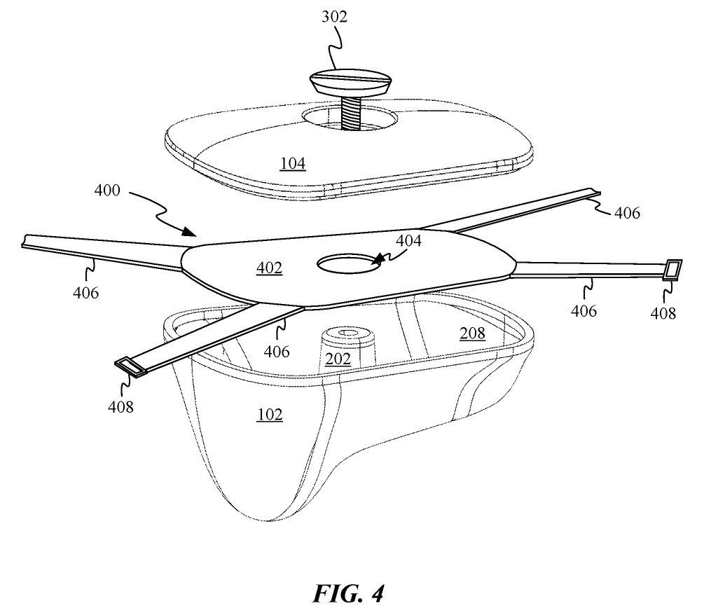

Referring now to FIG. 4, FIG. 4 shows an exploded view of tool 100 and a position of a strap assembly 400 relative to the components making up tool 100. As depicted, a central region 402 of strap assembly 400 is configured to fit within body opening 208 of main body 102. Central region 402 may be substantially the same size as opening 208 or smaller than opening 208. Central region 402 includes a central opening 404 positioned to allow second interior-facing protrusion 202 and an end of fastener 302 to extend through central opening 404. Fastener 302 may be a threaded fastener, or in some embodiments include other types of fasteners, which is discussed in detail below.

In some embodiments, strap assembly 400 includes a single strap or multiple straps 406 configured to wrap around a hand of a massage therapist to keep tool 100 secured to a hand of the massage therapist during use. FIG. 4 also shows how some of straps 406 include a buckle 408 for securing a respective strap 406 to another strap 406. While strap assembly 400 is shown including four straps 406 it should be appreciated that a smaller or larger number of straps 406 may be incorporated into a strap assembly 400.

For example, in some embodiments, a strap assembly may include one two, four or six straps. Furthermore, straps of a strap assembly may also be joined together by VELCRO or one or more clips instead of or in addition to the depicted buckles. It should also be noted that a size and shape of central region 402 may vary. For example, in a two strap configuration the central region may be just wide enough to define central opening 404 or alternatively may take the form of one or more elastic cords configured to keep the straps together when not in use and wrap around second interior-facing protrusion 202 when in use. A size and shape of central region may also vary in the event main body 102 includes multiple interior-facing protrusions that allow cap 104 to be secured to main body 102 by multiple fasteners.

Depending on how tightly fastener 302 secures cap 104 to main body 102 straps 406 may slide laterally within an interface between cap 104 and main body 102 to accommodate a desired angle of straps 406 to achieve a desired fit. Once a desired angular position of individual straps 406 is achieved, fastener 302 may be tightened further to keep straps 406 in a desired position. In other embodiments, main body 102 and/or cap 104 may define slots that accommodate and arrange straps 406 in a desired orientation.

In some embodiments, straps may include various alternative attachment strap systems to enhance usability, comfort, and adaptability for different massage techniques or user preferences. Such strap systems may include magnetic clasps, elastic straps with hook-and-loop fasteners, sliding lock mechanisms, interlocking straps with snap buttons, adjustable cinch clips, interchangeable strap systems, cross-strap harnesses, magnetic-interlocking straps with sensors, and zippered attachments. Individual implementation of such embodiments may be configured to address specific user needs or accommodate unique situations where additional functionality is required, which is discussed in detail below.

Magnetic clasps provide a simple yet effective way to attach straps. In this configuration, magnets are embedded at the ends of the straps or within fabric-covered segments. The magnets snap together, creating a secure connection that is both quick and easy to fasten or release. Such embodiment is particularly beneficial for users with limited dexterity, such as those suffering from arthritis, who may struggle with more complex attachment systems. The magnetic clasps allow the tool to be quickly donned or removed, which may be especially useful in fast-paced therapy sessions where time efficiency is advantageous.

In some embodiments, elastic straps with hook-and-loop fasteners include an elastic material, offering stretchability that conforms to various hand sizes and movements. Combined with hook-and-loop fasteners (such as VELCRO), these straps provide both flexibility and ease of adjustment. Elastic straps are ideal for situations where the user needs a secure fit without sacrificing mobility. This is particularly advantageous for therapists who need to adjust their grip or pressure frequently while working on different clients. The elasticity of the straps allows the tool to conform comfortably to the user’s hand, reducing the need for constant readjustment.

In some embodiments, a sliding lock mechanism allows the straps to be adjusted and locked into place with minimal effort. In such embodiment, the straps feature a ratchet-like system that enables the user to slide the straps to the desired tightness, which then locks into place. Such system provides a secure fit that may be easily adjusted and ensures that the straps will not loosen during use. Sliding lock mechanisms are advantageous for therapists who require a tight and stable attachment for deep tissue or other high-pressure massage techniques, where consistent pressure is advantageous over extended periods.

In some embodiments, interlocking straps featuring snap buttons or press-studs allow for multiple attachment points along the length of the straps. This design enables the user to adjust the straps to fit their hand comfortably by snapping the straps together at different points. The snap buttons provide flexibility in sizing and allow for a secure attachment that may be adjusted easily. This embodiment is particularly useful in shared-use environments, such as clinics or gyms, where different users may need to adjust the fit of the tool quickly. The snap buttons offer a reliable, customizable fit while maintaining simplicity in design.

In some embodiments, adjustable cinch clips offer a one-pull tightening mechanism that locks the straps into place. This type of attachment allows the user to easily adjust the fit of the straps by pulling them to the desired tightness and locking them with a clip. The clips ensure a snug fit without the need for complex adjustments and may be quickly released when the massage tool is no longer in use. This design is beneficial for users who require rapid adjustments, such as in athletic environments or during fast-paced therapy sessions, where securing and releasing the straps needs to be efficient.

In some embodiments, a cross-strap harness system provides additional stability by distributing pressure more evenly across the back of the hand. In this design, the straps crisscross over the hand, creating a harness that keeps the tool securely in place, even during vigorous use. The crisscross design helps reduce hand fatigue by distributing the weight and pressure more evenly, making it ideal for deep tissue or sports massage applications where higher pressure is required. This system would be particularly beneficial for therapists who perform intensive treatments, as it provides added support and prevents the tool from shifting during use.

In some embodiments, a strap system combines magnetic-interlocking straps with integrated sensors that provide real-time feedback on how the tool is being used. The magnetic straps lock together securely, while the sensors embedded in the straps or within the tool monitor data such as pressure application or hand alignment. For example, in some embodiments, the sensors may be integrated into the convex base of tool 100. Such data may be transmitted to an app or display, offering feedback on the quality and consistency of the massage. This system would be particularly useful in professional sports therapy or physical therapy, where detailed feedback on the effectiveness of the massage is advantageous, as well as for users who want to track their progress over time.

In some embodiments, the strap system may include zippered attachments provide a more fitted, secure option by allowing the straps to zip together, creating a snug and even fit around the hand. Zippers offer a reliable fastening system that ensures the straps stay tightly fastened during use without slipping. Zippered strap attachments are particularly useful for heavy-pressure applications, where maintaining a firm grip on the tool is advantageous. The zippered system may also be adjusted to fit different hand sizes, offering a personalized and stable fit, which is ideal for deep tissue work or situations where prolonged use is necessary.

In some embodiments, the straps may be part of an interchangeable system, allowing users to select different types of straps depending on the desired functionality. For example, the tool may be equipped with elastic straps for flexibility, magnetic clasps for ease of use, or cinch clips for a secure fit. This modular design allows therapists or users to swap out the straps based on the specific requirements of a session, providing versatility for different techniques and user preferences. This embodiment is particularly useful in professional settings, where a variety of users may have different needs, or for users who want a customizable massage experience

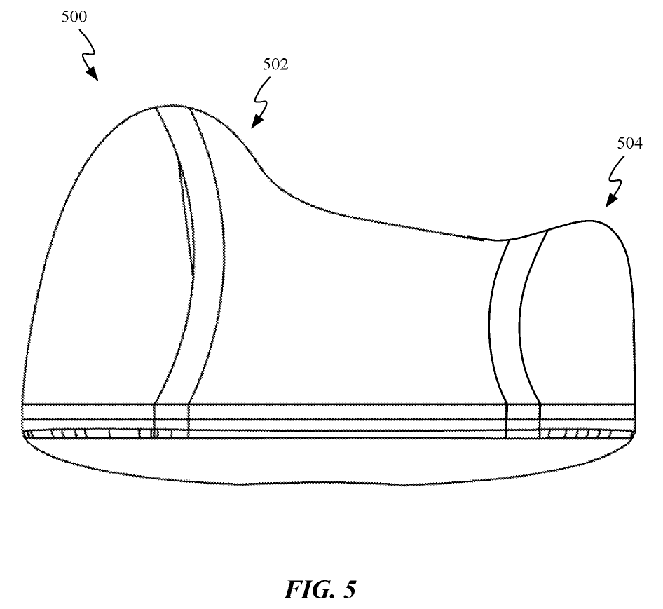

Referring now to FIG. 5, a side view of a hand-held massage tool 500 is shown, depicting an alternative embodiment of the tool's design. This embodiment features two distinct rounded protrusions: a first rounded protrusion 502 located at the front end of the tool and a second rounded protrusion 504 at the rear. The inclusion of both the first and second rounded protrusions allows tool 500 to offer enhanced versatility during therapeutic treatments.

In some embodiments, the first rounded protrusion 502 is shaped to apply general, broad pressure across a larger surface area, making it suitable for initial warm-up strokes or for addressing larger muscle groups. In contrast, the second rounded protrusion 504 is smaller (cf.02) and configured to provide more targeted, concentrated force. Such concentrated force allows the therapist to focus pressure on specific muscle knots, trigger points, or areas of tension that require a higher degree of precision.

Additionally, the presence of two rounded protrusions—502 and 504—enables the massage therapist to apply dual points of contact during a massage. This dual-contact feature may be particularly effective when working along the spine or large muscle groups, as it allows the therapist to engage two separate pressure points simultaneously. This design improves efficiency by covering more surface area in a single stroke, while also offering the ability to target specific regions with varying levels of force. The ergonomic shape of the tool ensures that both protrusions may be used interchangeably, depending on the needs of the client or the technique being applied.

Because the dual-protrusion design of tool 500 500 provides a unique combination of broad and targeted pressure capabilities, therapist enjoy greater control and flexibility when administering treatment. Whether addressing large muscle groups or pinpointing areas of tension, the hand held massage tool of the embodiments herein delivers effective and adaptable therapeutic results.

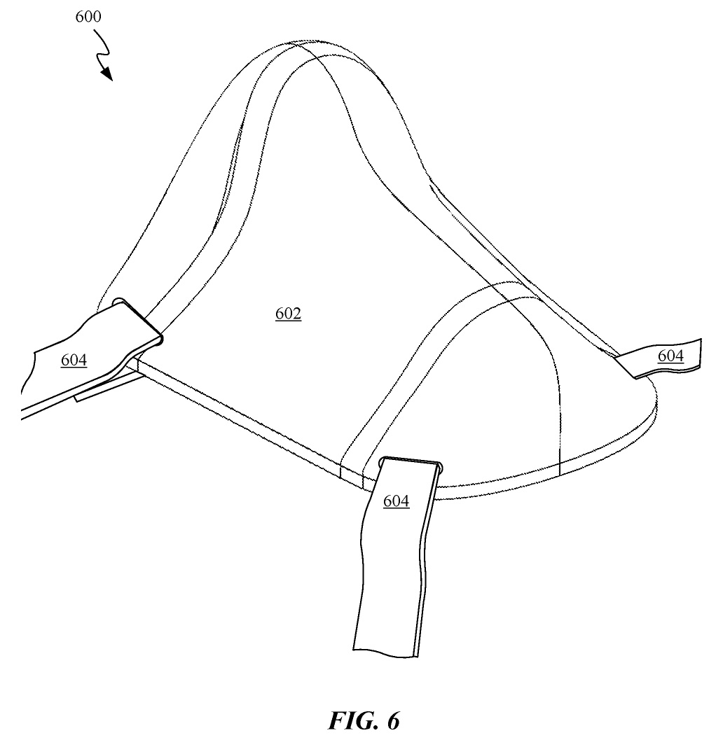

Referring now to FIG. 6, a perspective view of an embodiment of the hand-held massage tool 600 is shown (“tool 600), featuring a main body 602 that is a single, unified piece (i.e.monolithic). In contrast to other embodiments that may include a discrete cap, this design integrates the main body into one solid structure. The main body 602 includes multiple openings positioned around its periphery, designed to accommodate the attachment of straps 604. These openings provide flexibility for the attachment and adjustment of straps, ensuring that tool 600 may be securely fastened to the user's hand during use.

In some embodiments, the main body 602 may be formed from a solid piece of material, such as hardened plastic or metal, providing durability and stability during use. Examples of suitable plastics include high-density polyethylene (HDPE), Polypropylene (PP), polycarbonate, or acrylonitrile butadiene styrene (ABS). These plastics are known for their strength, impact resistance, and ability to withstand repeated use, making them ideal for a tool that will undergo significant physical pressure during massage sessions. Metal may include aluminum alloys (e.g.6061 or 7075), titanium, copper alloys (e.g.brass and/or bronze), carbon steel, or stainless steel, which offer excellent durability and resistance to corrosion while still being lightweight enough to use comfortably over extended periods. For example, stainless steel 304, 316L or Surgical Grade may be advantageous due to their chemical resistance properties. In some embodiments, copper or silver may be implemented, which may be beneficial for antibacterial properties.

For example, titanium, offers an exceptional balance of strength and weight, making it a premium choice for users who need a highly durable tool that is resistant to wear and tear, even in high-use environments. Aluminum alloys provide a lightweight alternative with good corrosion resistance, which can be anodized in various colors to create an appealing aesthetic. Stainless steel, known for its durability and resistance to corrosion, adds a sleek, professional finish to the tool, making it ideal for environments where frequent cleaning and sanitation are essential, such as clinical or therapeutic settings. Carbon Steel is known for its strength and durability. Although carbon steel requires a coating for corrosion resistance, carbon steel provides excellent stability and may withstand significant pressure, making carbon steel suitable for intensive massage applications.

In some embodiments, main body 602 may include a hollow configuration having an internal cavity or void. Such void or cavity reduces the overall weight of the tool, making such configuration easier to handle for extended periods without sacrificing functionality. A hollow void or cavity reduces material costs, particularly in cases where more expensive metals or high-grade plastics are used. The decision between a solid or hollow design may depend on the specific needs of the therapist or user. For example, a hollow design might be preferred for users who require a lighter tool for less intense massage sessions, while a solid design may be advantageous in applications where higher pressure and durability are needed.

The materials used to construct tool 100, 500, 600 may vary significantly depending on the desired properties of the final product. In addition to the plastics and metals mentioned above, various polymers, such as thermoplastic elastomers (TPE) or polyurethane (PU), may be used to enhance the tool's flexibility or provide additional comfort. Metal alloys like titanium may also be considered for users who need a highly durable, lightweight option that resists wear and tear.

In some embodiments, glass, acrylic, and or other clear cast plastic may be utilized. In some embodiments, materials such as glass, acrylic, or other clear cast plastics may be utilized, adding a unique, transparent aesthetic while retaining functional benefits. Clear materials such as acrylic offer high impact resistance and durability, while providing a polished, visually appealing finish. Glass or clear acrylic components could be used in tools intended for display, high-end retail, or luxury therapeutic applications, enhancing the tool’s visual appeal while offering a clean, smooth surface that is easy to sanitize. Clear plastics also allow for internal components or design features to be visible, which may be useful in showcasing embedded features or branding elements.

For example, in some embodiments, tool 100, 500, 600 may include borosilicate glass, which is known for its thermal and chemical resistance. Borosilicate glass is highly durable and can withstand temperature changes without breaking. A smooth, non-porous surface makes cleaning and sanitation easy, which is advantageous in professional settings. Additionally, a clear finish allows for a transparent, visually appealing design. In some embodiments, tool 100, 500, 600 may include tempered glass, which is strengthened through a heating and cooling process, making such glass highly resistant to impacts and breakage. Tempered glass provides durability and a sleek aesthetic, with a smooth surface that is easy to maintain. It can add a premium feel to the tool, particularly in luxury or high-end massage products. In some embodiments, tool 100, 500, 600 may include fused quartz glass, which has excellent thermal stability and hardness. Fused quartz is ideal for tools that involve heated applications and is highly durable and resistant to scratches, providing a long-lasting, smooth surface.

In some embodiments, tool 100, 500, 600 may include ceramics including alumina, zirconia, and/or cordierite. Alumina (Aluminum Oxide) is lightweight, wear-resistant, and has a smooth finish. Its hardness and ability to maintain shape under pressure make it ideal for massage tools that require durability without added weight. Alumina is also non-porous, easy to sanitize, and resistant to scratches, making it suitable for long-term use. Zirconia (Zirconium Dioxide) ceramics are incredibly tough and resistant to cracking, making them suitable for high-stress applications. They offer a sleek, smooth surface that is resistant to corrosion and wear, with a premium appearance. Additionally, zirconia can be produced in various colors, adding customization options for aesthetics. Cordierite is known for heat resistance and strength, cordierite ceramic may be used in massage tools embodiments configured to to hold heat. Such material maintains stability under high temperatures, making it ideal for tools that incorporate warming elements for therapeutic massage.

In some embodiments, tool 100, 500, 600 may include glass-ceramic materials including pyroceram, zerodur, and/or lithium aluminosilicate. Pyroceram is a glass-ceramic material with excellent resistance to thermal shock, making it suitable for massage tools that incorporate heat. Its durability and heat resistance provide stability under various conditions. Zerodur has minimal thermal expansion, making it highly stable under temperature changes. It’s scratch-resistant and durable, providing a smooth, hard surface that maintains its appearance and functionality over time. Lithium Aluminosilicate is known for their high strength and thermal resistance, making them ideal for high-durability applications. Their non-porous surface provides easy maintenance and sanitation, and they can withstand frequent, intensive use.

In some embodiments, an exterior coating may be applied to the main body to improve the tool's performance or aesthetics. For example, a rubberized coating might be added to improve grip and comfort during use, especially when the tool is used with lotions or oils, which may make the surface slippery. A rubberized surface would offer a non-slip grip, ensuring that the tool remains firmly in the user’s hand even during intense pressure applications. Alternatively, a powder-coated finish may be applied to metal versions of the tool to enhance its resistance to corrosion and scratches. Powder coatings are available in various textures and colors, which may provide both functional and aesthetic benefits.

In some embodiments, when tool 100, 500, 600 is manufactured using injection molding, such embodiments may include in-mold texturing. In-mold texturing allows for the addition of detailed surface patterns or textures directly onto the tool's exterior during the molding process. Such technique can enhance both the aesthetic and functional qualities of the massage tool. For instance, tool 100, 500, 600 may include a textured grip area that improves handling, providing a non-slip surface that allows users to maintain control even when applying substantial pressure or using oils and lotions.

In addition to grip enhancement, in-mold texturing may add a premium look and feel to tool 100, 500, 600, with options for fine textures, matte finishes, or intricate patterns that contribute to the tool’s overall visual appeal. Such customization can be especially beneficial for tools intended for professional settings or high-end markets, where both functionality and aesthetics are prioritized. Furthermore, in-mold texturing is a cost-effective way to add complexity to the surface design without requiring additional post-processing, making in-mold texturing an efficient implementation for large-scale manufacturing.

In some embodiments, the surface of the tool 100, 500, 600 may include an antimicrobial coating, particularly beneficial in environments where hygiene is a concern, such as massage therapy clinics or wellness centers. These coatings may inhibit the growth of bacteria, mold, and fungi on the surface of the tool, promoting cleanliness and reducing the need for constant sterilization. This would be especially useful in professional settings where multiple clients use the tool in quick succession.

For example, in some embodiments, enhance hygiene, especially in professional or shared-use environments, an antimicrobial coating may be applied to the hand strap as well as the main body of the massage tool. Antimicrobial coatings on the strap help inhibit the growth of bacteria, mold, and fungi, ensuring that the tool remains sanitary between uses and reducing the need for frequent cleaning. This feature is particularly advantageous in clinical or wellness settings where multiple users might handle the same tool over short periods.

In some embodiments, the strap may incorporate silver thread woven into its fabric. Silver is known for its natural antimicrobial properties, which help to further reduce microbial growth on the strap surface. Silver ions disrupt the cellular functions of bacteria and other microbes, offering continuous protection. The use of silver thread not only enhances hygiene but also provides a long-lasting solution that does not wear off like some surface coatings might. Combining antimicrobial coatings with silver-threaded fabric results in a strap that is both durable and hygienic, making such embodiment ideal for high-touch applications.

In some embodiments, a heat-resistant or heat-retaining coating may be applied to create a tool that retains warmth during use, mimicking the effect of heated stones or other warming devices commonly used in therapeutic massages. Such feature would allow the tool to deliver a deeper, more relaxing massage experience without needing additional heating elements.

Thus, tool 600 demonstrates a versatile design that may be customized with various materials and coatings to suit different needs. Whether focusing on durability, weight reduction, improved grip, or enhanced hygiene, the selection of materials and finishes allows for a wide range of customization, making this design adaptable for both professional and personal use.

Accordingly, the embodiments described above enhance therapeutic treatments by providing versatile, ergonomic, and durable solutions for both professional and personal use. Through innovative design features such as the incorporation of contoured protrusions, adaptable strap systems, and customizable material options, the embodiments described herein offer improved precision, control, and comfort during massage applications. Individual embodiments catering to different user needs, whether for general muscle relief, targeted deep-tissue therapy, or flexibility in technique.

The tool's modularity in some embodiments allows for the attachment of interchangeable components, while the monolithic embodiments offer durability and ease of use, with minimal maintenance required. Materials ranging from plastics to glass ceramics and metals, combined with various optional coatings, ensure that the tool may be tailored for specific performance characteristics, such as enhanced grip, antimicrobial properties, or weight customization. These features contribute to the tool’s practicality, longevity, and ease of use in diverse settings, including clinical environments, sports therapy, and home use.

This massage tool and systems and apparatus described herein represents a significant advancement in ergonomic design and functionality, offering a balance of durability and versatility for massage therapists and individuals alike. Whether through the precision of dual-contact points, the stability of embedded straps, or the benefits of weight customization, the embodiments described above address key challenges in delivering consistent and effective massage therapy.

While the descriptions provided are specific to particular embodiments, they are not intended to limit the scope of the claims, which are intended to cover various modifications and equivalents. The design and construction described herein are adaptable and may be further refined and expanded in response to evolving user needs and industry trends. A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations may be made hereto without departing from the spirit and scope of the present disclosure.

What is claimed is:

1. A hand-held massage tool, comprising:
a main body, comprising:
a first side contoured to form a rounded protrusion at a first end of the main body and a ridge extending from the rounded protrusion to a second end of the main body that slopes downward toward the second end; and
a second side, opposite the first side, defining an opening;
a cap that covers the opening and forms an interior volume in cooperation with the main body; and
a fastener securing the main body to the cap.

2. The hand-held massage tool of claim 1, further comprising:
a strap assembly operable to secure the hand-held massage tool to a hand of a user, wherein at least a portion of the strap assembly is positioned between the cap and the main body.

3. The hand-held massage tool of claim 1, wherein the strap assembly comprises a central region disposed within the interior volume and one or more straps extending from the central region and out of the interior volume through an interface between the main body and the cap.

4. The hand-held massage tool of claim 1, wherein the rounded protrusion has a size and shape corresponding to an end of an olecranon.

5. The hand-held massage tool of claim 1, wherein the main body comprises an aperture configured to receive the fasteners through a fastener opening defined by the cap.

6. The hand-held message tool of claim 1, wherein an exterior-facing surface of the cap has a convex geometry.

7. The hand-held massage tool of claim 1, wherein the rounded protrusion and the ridge are symmetric along an axis that extends from the first end of the main body to the second end of the main body.

8. The hand-held massage tool of claim 1, wherein the rounded protrusion is a first rounded protrusion and the first side of the main body is further contoured to include a second rounded protrusion at a second end of the main body that is smaller than the first rounded protrusion.

9. The hand-held massage tool of claim 1, wherein the main body further comprises a first protrusion extending into the interior volume and wherein the first protrusion defines an aperture.

10. The hand-held massage tool of claim 9, wherein the cap comprises a second protrusion extending into the interior volume that defines a fastener opening aligned with the aperture.

11. The hand-held massage tool of claim 10, wherein the fastener extends through the fastener opening and comprises a distal end engaged within the threaded aperture defined by the first protrusion.

12. A hand-held massage tool, comprising:
a main body contoured to form a rounded protrusion at a first end of the main body and a ridge extending from the rounded protrusion to a second end of the main body that slopes downward toward the second end.

13. The hand-held massage tool of claim 12, further comprising a strap assembly operable to secure the main body to a hand of a user.

14. The hand-held massage tool of claim 13, wherein the main body defines a plurality of openings and a plurality of straps of the strap assembly are routed through the plurality of openings to secure the strap assembly to the main body.

15. The hand-held massage tool of claim 13, wherein the rounded protrusion and the ridge are positioned on a first side of the main body and a second side of the main body defines an opening.

16. The hand-held massage tool of claim 13, further comprising:
a cap that covers the opening and forms an interior volume in cooperation with the main body; and
a fastener securing the cap to the main body.

17. The hand-held massage tool of claim 16, wherein at least a portion of the strap assembly is positioned between the cap and the main body.

18. The hand-held massage tool of claim 17, wherein the portion of the strap assembly positioned between the cap and the main body defines a strap opening and wherein the fastener extends through the strap opening.

19. The hand-held massage tool of claim 18, wherein the cap comprises an alignment ridge configured to assist in aligning the cap with the main body.

20. The hand-held massage tool of claim 12, wherein the rounded protrusion has a size and shape corresponding to an end of an olecranon.
